(19) United States
(12) Patent Application Publication
(10) Pub. No.: US 2007/0095906 A1
(43) Pub. Date: May 3, 2007

(54) Configuration management and asset tracking method and system

(76) Inventors: Mark A. Camilleri, Loomis, CA (US); Connie Jo Turnbull, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,906

(22) Filed: Oct. 27, 2005

(51) Int. Cl. G06Q 30/00

(52) U.S. Cl. 235/385

(57) ABSTRACT

A method and system is used for tracking and locating printer assets in an enterprise. Tracking these assets begins by receiving operational information that enables a printer to interoperate with computers and other printers on a network. Next, the asset tracking information associated with the printer is identified and stored along with the operational information onto the printer for operation of the printer and subsequent retrieval for inventory control. Locating printer assets begins by receiving a request for an inventory of printers on a network according to inventory criteria. The inventory criteria are then used to query one or more printers over the network to obtain operational configuration information and asset tracking information stored on the one or more printers. The resulting operational configuration information and asset tracking information is presented from the printers that meet the inventory criteria. This information is useful in printer management and inventory control.

### BACKGROUND

It has become increasingly difficult to track computing equipment and printers in datacenters and enterprises. In the datacenter, the problem is generally confined to one or two areas but in the enterprise these devices are often in different campuses spanning a wide geographic area. To further complicate matters, computers and printers initially installed in one location are frequently moved or relocated as the organization changes and individuals are relocated. Consequently, asset tracking and inventory management operations are only as accurate as the systems that keep track of these rapid changes over time.

In the case of computer systems, it is possible to remotely log onto each individual computer system on a network and take inventory. Some companies remotely store a file on each computer system containing an inventory of the computer contents as well as including asset tracking information. A central computer uses this remotely stored file to perform inventory and asset tracking functions as needed. This approach works wells with computers primarily because they already have large amounts of storage, general purpose operating systems and powerful general purpose processing capabilities. However, if the remotely stored file on each computer becomes inaccessible then inventory tracking will fail. For example, some computers may not be accessible if firewall/virus protection is running or the hard disk holding the asset information has suffered a fatal error or been corrupted.

Other peripheral devices like printers and scanners do not generally have general purpose operating systems, processors and storage devices. These purpose-oriented devices are designed to perform a single function like printing or scanning. Consequently, the inventory approach used on computers described previously is not available. Even if printers, scanners or other devices did have storage devices, opening them up for access by remote applications would also yield them vulnerable to computer viruses and other malicious behavior.

Hewlett-Packard has developed a remote management product for networked printers and other devices called Web Jetadmin (Web Jetadmin is a trademark of Hewlett-Packard Development Company, L.P.). The Web Jetadmin product provides a central facility for accessing networked printers and other devices to determine configuration information and check in operating status. A card installed on each Web Jetadmin accessible printer called a Jetdirect card receives commands using simple network management protocol (SNMP) from a computer over the network (Jetdirect is a trademark of Hewlett-Packard Development Company, L.P.). These commands in SNMP are converted to a printer management language (PML) that interfaces with the printer. For example, a PML command can be issued using SNMP to turn the printer offline from online or vice-versa; these PML commands may also be used for other functions including changing default print resolutions or certain communication protocol parameters. Unfortunately, Web Jetadmin and Jetdirect do not provide a facility for robust asset management and inventory control over a network.

### BRIEF DESCRIPTION OF THE DRAWINGS

FIG. 1 is a schematic diagram of a system for configuring and tracking printers and other peripheral devices in accordance with one implementation of the present invention;

FIG. 2A depicts a graphic user interface (GUI) for managing printer assets and other device assets in accordance with one implementation of the present invention;

FIG. 2B depicts another graphic user interface (GUI) for getting status on the printer assets and other devices in accordance with one implementation of the present invention;

FIG. 2C illustrates a schematic of the communication hardware and communication flow on a device managed in accordance with implementations of the present invention;

FIG. 3 is a flowchart diagram of the operations for tracking printer assets and other device assets in accordance with implementations of the present invention;

FIG. 4 is a flowchart of the operations used to locate printer and device assets in accordance with one implementation of the present invention; and

FIG. 5 is a schematic diagram of an asset management system and logic used to track and locate printers and devices in accordance with one implementation of the present invention.

Like reference numbers and designations in the various drawings indicate like elements.

### SUMMARY

One aspect of the present invention features a method and system for tracking printer and device assets. Tracking these assets begins by receiving operational information that enables a printer to interoperate with computers and other printers on a network. Next, the asset tracking information associated with the printer is identified and stored along with the operational information onto the printer for operation of the printer and subsequent retrieval for inventory control.

Another aspect of the present invention includes a system for locating printer and device assets. Locating printer assets begins by receiving a request for an inventory of printers on a network according to inventory criteria. The inventory criteria are then used to query one or more printers over the network to obtain operational information and asset tracking information stored on the one or more printers. The resulting operational information and asset tracking information is provided by the printers that meet the inventory criteria. This information is useful in printer management and inventory control.

### DETAILED DESCRIPTION

Implementations of the present invention are used for configuring printer or devices with asset information and taking inventory and tracking these assets. Aspects of the invention can also be used for many other types of peripheral devices and should not be limited to only printer type devices. Printers and other devices designed in accordance with aspects of the present invention have a storage area embedded on a network card that communicates using a network protocol to one or more computers on a network. A remote computer determines the asset tracking and inventory information and then accesses the printer to store this information on this storage area on the network card. Later, the remote computer accesses the network card on the printer to obtain asset tracking information during an inventory operation or event.

While there are many advantages to the present invention, a few of these advantages have been included herein. Asset tracking can be performed on all printers and devices capable of being attached to the network. If a network card can be installed on the printer or device then asset tracking can be performed in accordance with implementations of the present invention. For example, the network card may need to be compatible with an SNMP protocol and the Jetdirect and/or Web Jetadmin specifications.

Storage and processing capabilities are used on the network card so there is no interference with printing or other functions. An inventory system can take inventory of a printer device while the printer is printing or even if the printer is out of paper or having a toner cartridge replaced. In the unlikely event the printer engine malfunctions, the inventory information remains accessible as long as the printer is powered on and the device remains attached to the network. This separation between the printer device and the network card also acts as a barrier from hackers attempting to invade the network through a network attached printer or other device. It also ensures that the printer remains accessible even when the printer is upgraded or certain components replaced. For example, the asset information on a malfunctioning printer can be preserved if the network card on the failing printer is swapped in on a new replacement printer. Many other benefits are contemplated for the various aspects of the invention yet have been omitted for brevity.

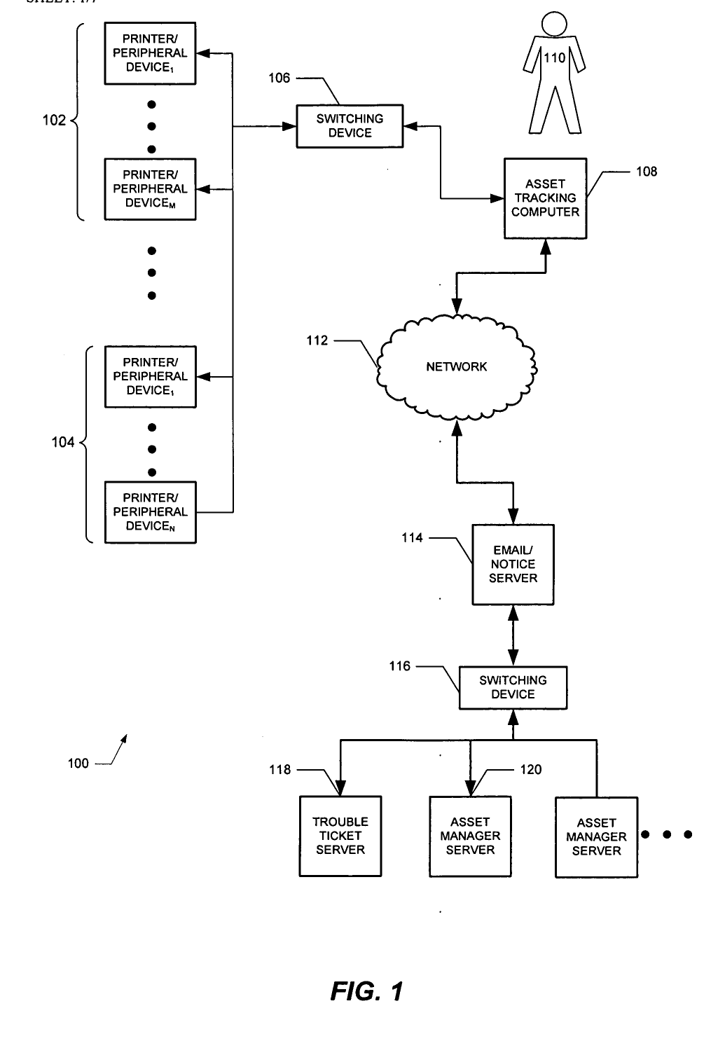

FIG. 1 is a schematic diagram of a system 100 for configuring and tracking printers and other peripheral devices in accordance with one implementation of the present invention. It should be understood while aspects of the present invention are described with respect to printers, it is contemplated that similar concepts and teachings can also be applied to any device that may benefit from centralized configuration management and asset tracking operations.

Accordingly, system 100 illustrates one set of printers identified as printer set 102 and another set as printer set 104. There may be an arbitrary number of printers and sets of printers supported by system 100 in accordance with implementations of the present invention. Further, each set of printers can be located in different geographic areas and each printer can be located in different buildings, floors and/or offices. Of course, it is also possible that the individual printers are all located in a single office or area such as a large datacenter. In one implementation, each printer is connected to a network through a network card designed in accordance with implementations of the present invention having an embedded storage area and capable of communicating in a network protocol language compatible with SNMP and a printer configuration protocol such as printer management language (PML).

Printer set 102 through printer set 104 communicate over switching device 106 to an asset tracking computer 108 designed in accordance with implementations of the present invention. Switching device 106 schematically represents a single switch or a complex hierarchy of network switches and equipment needed to connect printer set 102 through printer 104 in an enterprise to asset tracking computer 108.

Asset tracking computer 108 is network attached through switch 106 to each printer in printer set 102 through printer set 104. Loaded onto asset tracking computer 108 is software that communicates printer operational information and asset tracking information associated with each printer consistent with aspects of the present invention. In addition to printers, alternate implementations of asset tracking computer 108 can also communicate with computers and other devices on the network having a network card compatible with implementations of the present invention. For example, a Jetdirect card manufactured by Hewlett-Packard Incorporated is one such card compatible with the Web Jetadmin software and plug-ins designed in accordance with aspects of the present invention.

In one implementation, asset tracking computer 108 communicates printer asset information and configuration information over network 112 to an email/notice server 114 through a switching device 116. Once again, switching device 116 schematically represents one or more switches rather than a single switch or device. This email/notice server 114 analyzes each email sent from asset tracking computer 108 to determine an appropriate disposition. In some instances an email containing inventory information is forwarded to an accounting department 122 or person in response to a request from the department for asset information. In other instances, the email may include inventory information in conjunction with an alert that a printer has failed, needs repair or needs consumables (i:e., paper, toner, ink) replenished. Asset information can be used in conjunction with these alerts to also locate the failing printer and charge repair costs repairs costs back to a specific cost center in an enterprise. It is also possible that all inventory information and requests are kept in an asset manager server 120 to keep track of printers and other devices as they are used, configured and managed over time. For example, this could be used for associating usage and costs for consumables and repairs with certain cost centers in an enterprise over time.

In operation, each printer in printer set 102 through printer set 104 may be removed and moved to another location in an enterprise. An operator 110 checks asset tracking information associated with the printer and enters updated information reflecting the new location of the printer in the enterprise. If necessary, operator 110 may also update configuration information for the printer as well. For example, operator 110 may enter a new office, building and address location information for the printer once it is moved and installed in the new location. Once all printers are relocated and asset tracking information updated, a real-time report may be sent to asset manager server 120 for use by trouble ticket server 118, accounting department 122 or any other group in the enterprise.

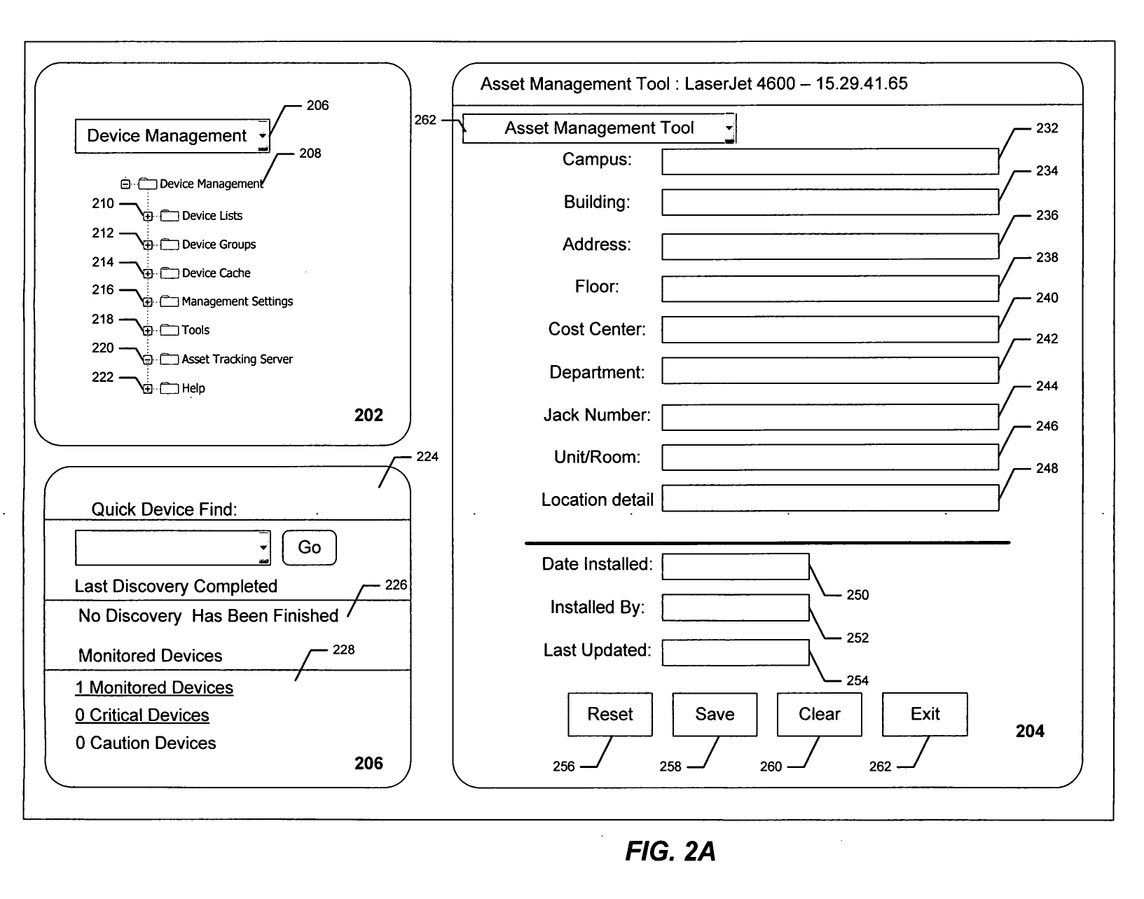

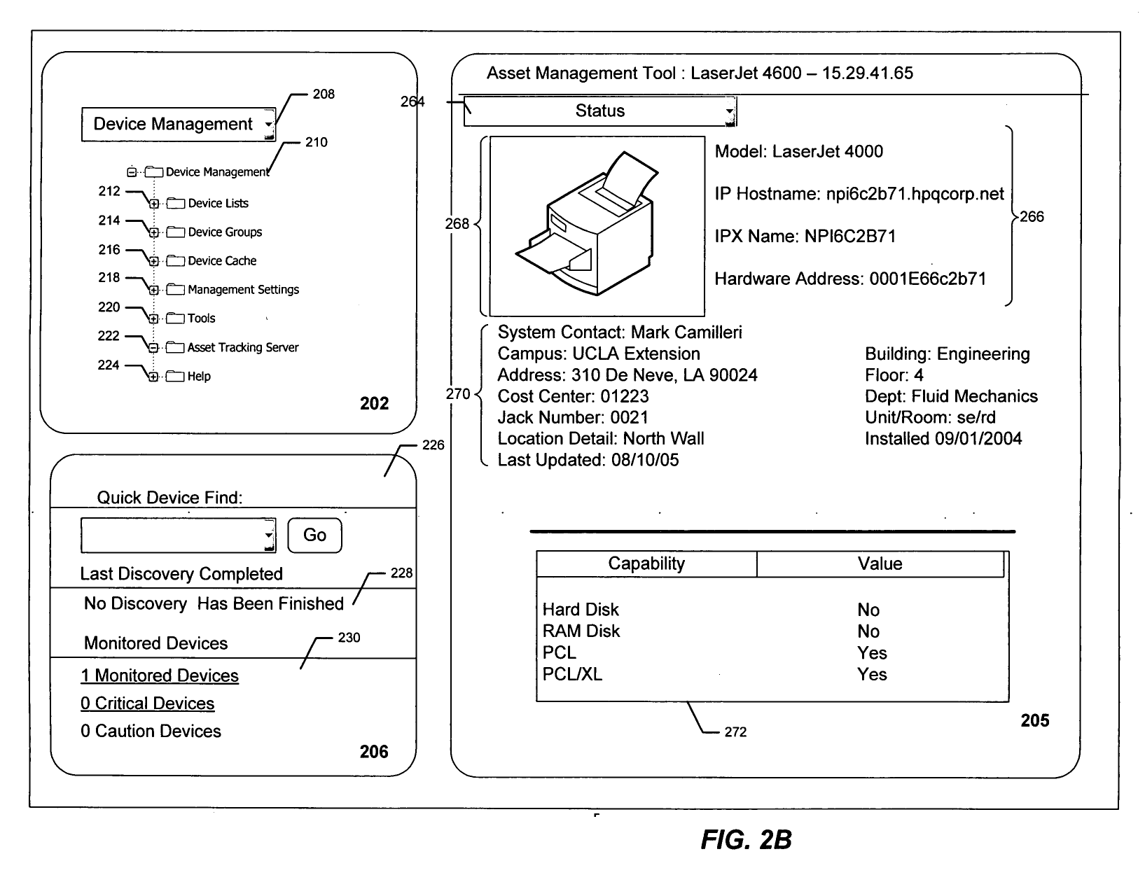

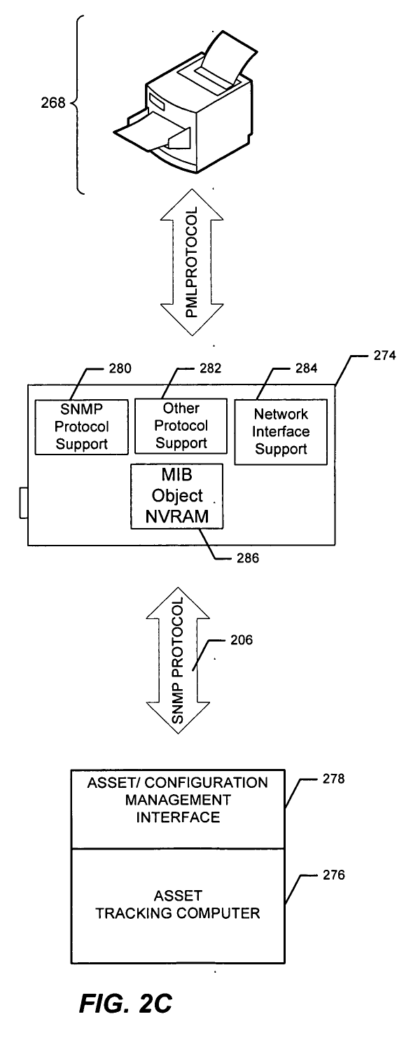

FIG. 2A depicts a graphic user interface (GUI) for managing assets of printers and other devices in accordance with one implementation of the present invention. The GUI in FIG. 2A includes a device management area 202, an asset management area 204 and a search area 206. Device management area 202 includes a hierarchical schematic representation of devices being managed and categorization of these devices in several groups. In this example, devices are classified under device management 208 into device lists 210, devices groups 212, device cache 214, management settings 216, tools 218, asset tracking server 220 and help 222.

Device lists 210 includes all devices being managed as well as a list of devices not yet in a “Device group” or “New devices” that are newly attached to the network and not yet configured. Device groups 212 is a configurable list of devices divided into different groups as needed by the organization or enterprise. For example, one group could be all printers used by the doctors on one wing of a hospital while another group could be all the printers used by hospital administrators on another floor of the hospital. In any event, the different device groups are user configurable.

Device cache 214 describes information stored in cache scheduled for export (e.g., to another application for example) including export parameters related to the device and parameters to be restored to the device when the device is reset. For example, the exported information from device cache 214 can be to a comma-separated values (CSV) file or to an XML compatible file. Specific information to be exported from device cache 214 is indicated by selecting one of many predefined views or by creating a custom view. Device cache 214 has information that can be viewed in a spreadsheet or entered into a database depending on the particular needs.

Management settings 216 include discovery results and network settings for the devices being managed. The discovery results pertain to network queries and addresses discovered and associated with particular devices on the network. Network settings concerns specific features and services enabled and associated with each device on the network. For example, the network settings can include SNMP settings, bootp settings, tftp settings and polling settings for each printer or device on the network.

Asset tracking server 220 refers to one or more different aspects of the present invention. In one implementation, asset tracking server 220 receives information through asset management tool 204 interface as depicted. This part of the GUI is accessed by selecting “Asset Management Tool” 262 in the pull-down menu. Fields presented for asset tracking of the particular device may include campus 232, building 234, address 236, floor 238, cost center 240, department 242, jack number 244, unit/room 246 and location detail 248. Installation details may also include date installed 250, installed by 252 and last updated 254. Entries made in one or more of these fields are committed to a database or erased using one or more of the control buttons labeled reset 256, save 258, clear 260 and exit 262.

For example, a printer moved from one building to another building in the same campus would likely require an operator to change at least one or more fields to reflect the change. The fields needing modification may include: building 234, address 236, floor 238, cost center 240, department 242, jack number 244, unit/room 246 or location detail 248. If the building is in the same campus then the campus information would not change. In general, if data installed 250 is later in time than the last updated 254 entry several different asset field entries may need revision.

Search area 206 contains three different areas related to searching for devices. Pattern match area 224 allows for entry and searching of specific printers or devices on the network. These can be free form searches that conform to regular expression parsing or some other type of wildcard and pattern matching.

Discovery area 226 concerns the last time printers or devices on the network were polled and queried for configuration and asset information in accordance with aspects of the present invention. Finally, monitor area 228 concerns current alert status for different printers and devices on the network. Monitored devices include all devices on the network and being monitored for alerts. Critical devices indicate the devices reporting errors or conditions requiring immediate attention while caution devices indicate the devices with problems that are less critical in nature. For example, a toner low alert on a printer may be caution type event while a fuser overheating on a large printer may be a more critical event that needs immediate attention.

FIG. 2B depicts another graphic user interface (GUI) for getting status on the printer assets and other devices in accordance with one implementation of the present invention. Like the GUI depicted in FIG. 2A, this GUI displays a device management area 202 and search area 206 but instead includes a status area 205. Device management area 202 and search area 206 are essentially the same as previously described. This GUI portion displayed in FIG. 2B is accessed by selecting “Status” 264 in the pull-down menu rather than the “Asset Management Tool” 262 as previously selected and described in FIG. 2A.

Status 264 includes operational information 266, a device image 268, asset tracking information 270 and device capabilities 272. In this example, the device is a printer device however these fields can be used and applied for many other types of devices. Device image 268 provides an iconic representation of the printer or device being managed and may reflect certain useful information about the device visually. For example, no paper may appear in the printer if it is out of paper or a button may be flashing red on the front panel of the device to indicate that an alert has occurred on the device and needs immediate attention.

Operational information 266 includes a model description of the device, one or more network address details for reaching the device over a network and hardware addresses that may refer to a MAC address for the network card or may refer to an actual serial number associated with the printer or device. In this example, hardware address “0001E66c2b71” refers to the MAC address of the network card installed in the device.

Asset tracking information 270 includes one or more fields useful in keeping track of printers or other devices for inventory control, general accounting or information technology management. In accordance with implementations of the present invention, this asset tracking information 270 is kept on the printer or device and retrieved in real-time as the asset tracking information is needed. Only certain fields need to be updated when the printer or device is moved thus saving time re-entering data.

In this example, the asset tracking information 270 retrieved from “LaserJet 4600” having IP address 15.29.41.65 describes the system contact or administrator responsible for managing the device and multiple geographic descriptions useful in locating the device. For example, this asset tracking information indicates that the printer is located on the UCLA Extension Campus at 310 De Neve, Los Angeles 90024. It also indicates that costs associated with this asset can be billed to “Cost center” 01223 for the benefit of the Fluid Mechanics department in the Engineering School. It also indicates that the installation occurred on “Sep. 1, 2004” and that the system has been updated more recently on “Aug. 10, 2005”.

FIG. 2C illustrates a schematic of the communication hardware and communication flow on a device managed in accordance with implementations of the present invention. In this example, a printer 268 has a network card 274 installed internally and connected to an internal bus within the printer. Network card 274 could also be attached externally and would then be configured as an external device with its own power supply and attached using Firewire, USB or with some other connectivity method to printer 268.

Network card 274 operates to connect printer 268 to a network with other printers and computers that communicate and interoperate with printer 268. Network card 274 includes chips and firmware indicated schematically providing SNMP protocol support 280, network interface support 284 and storage for MIB (management interface base) objects in NVRAM (non-volatile RAM) 286. In practice, these functionalities can be implemented using greater or fewer discrete components than alluded to in this diagram as dictated by the particular implementation and design. Other protocol support 282 represents one or more other types of typical protocol support found on conventional network devices and well-known to those skilled in the art. For example, other protocol support 282 may include operations used to process data on a TCPIP communication stack.

In operation, network card 274 receives requests in an SNMP protocol 206 from asset/configuration management interface 278 running on asset tracking computer 276. For example, asset/configuration management interface 278 may include one or more different GUI screens including, in addition to many other screens, the GUIs depicted in FIG. 2A and FIG. 2B. SNMP protocol support 280 parses and interprets these commands as typically being “GET”, “SET” or “TEST” commands. The SNMP GET command requests information, the SET command typically sets some values and the TEST command may perform some conditional operation or test between two different fields/parameters or settings from the target printer.

Using a “SET” command, one implementation of the present invention stores asset tracking information with the MIB Object NVRAM 286 on network card 274. For example, the 255 character field of the “sysLocation” MIB object (.1.3.6.1.2.1.1.6) in Jetdirect NVRAM can be used to store this information. Entering the one or more asset tracking information entries in NVRAM ensures that the data will not be lost if the printer is rebooted, reset or repaired. To save space, multiple fields of information may be entered into a single MIB object entry in the MIB Object database in NVRAM. These multiple fields entered in single MIB object may be compressed, comma-delimited, run-length encoded or use other schemes for data compression and entry. The data can also be encrypted if there is a need to keep the information confidential and not generally available over the network. This is a cost effective solution as it does not require an additional or separate NVRAM field for every piece of asset information requiring storage. Further, using the location field would keep Web Jetadmin software implementation aspects of the present invention compatible with a full range of legacy Jetdirect cards residing in older and new printers alike.

A GET command is used to retrieve asset tracking information and other information from network card 274 and printer 268. If it is necessary SNMP protocol support 280 can convert an SNMP command into printer management language (PML) requests to obtain detailed printer specific information from the printer engine or other subsystems. For example, a PML request can be made to determine if the toner cartridge is low or a total count of pages printed on printer 268. These PML requests are processed and returned to network card 274 and converted back into an SNMP command to be transmitted using SNMP protocol 206 back up to asset tracking computer 276 and asset/configuration management interface 278.

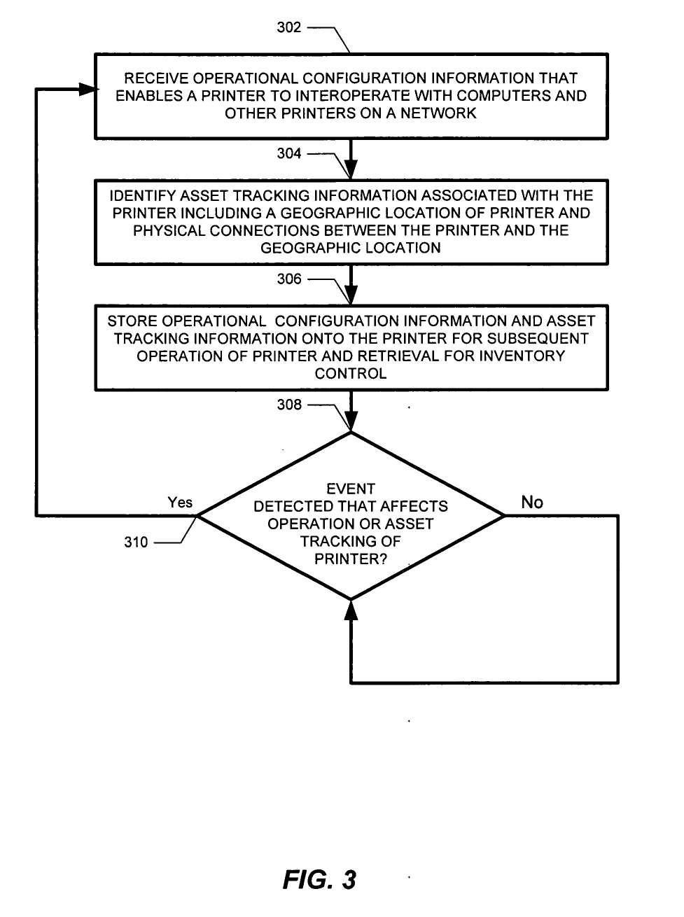

FIG. 3 is a flowchart diagram of the operations for tracking printer assets in accordance with implementations of the present invention. While printers are provided as an example use, alternate implementations can be used to track many other types of devices other than printers.

Initially, one implementation of the present invention receives operational information that enables a printer to interoperate with computers and other printers on a network (302). Typically, operational information includes printing parameters and communication parameters for printer operation on the network. This can include network settings, communication rates and other details concerning the protocols used to communicate with the printer. It may also include information for setting alerts and email addresses to send the alerts if and when they might occur. A Web Jet Admin (WJA) graphical user interface can be used to receive operational information and identify tracking information associated with the printer. Alternatively, other interfaces other than the WJA that implement aspects of the present invention can also be used.

In addition to the operational information, implementations of the present invention further identify asset tracking information associated with the printer (304). This information may include a geographic location of the printer and physical connections between the printer and the geographic location identified. For example, this may include specifying a geographic location of the printer by way of an address for a building and a room in the building and then listing one or more jacks in the room in the building to provide power and networking.

Once the operational information and asset tracking information is determined, aspects of the present invention store the operational information and asset tracking information onto the device for subsequent operation of printer and retrieval for inventory control (306). To store the information, the printer receives one or more messages transmitted over the network using a network protocol suitable for the printer. For example, an SNMP compatible protocol can be used to communicate with the printer as it is a relatively lightweight protocol and can be processed quickly. Each message or command received by the printer is then parsed into operational information and asset tracking information.

The operational information is generally used for configuring and communicating with the printer. In contrast, asset tracking information describes information related to taking inventory and describing the location of the printer. In an SNMP compatible protocol, the asset tracking information is transmitted using certain MIB objects. These MIB objects can be identified and classified according to their descriptors and identifiers. In accordance with implementations of the present invention, some MIB objects are classified as containing operational information while other objects contain asset tracking related information. For example, asset tracking information may include campus, building, address, floor, cost center, department, jack number, unit/room and other location details for the printer or device. It also may include other asset related information including the date installed, the person it was installed by and last updated date for record keeping purposes.

At predetermined time intervals, implementations of the present invention determines if there was an event detected that affects operational information or asset tracking information for the printer or device (310). If no changes are made to a printer or other device and it has not been relocated within an enterprise then it is assumed that the asset tracking information does not need updating. Alternatively, if a printer or other device has been relocated/moved and the configuration has changed then it may be necessary to update the asset tracking information stored on the printer

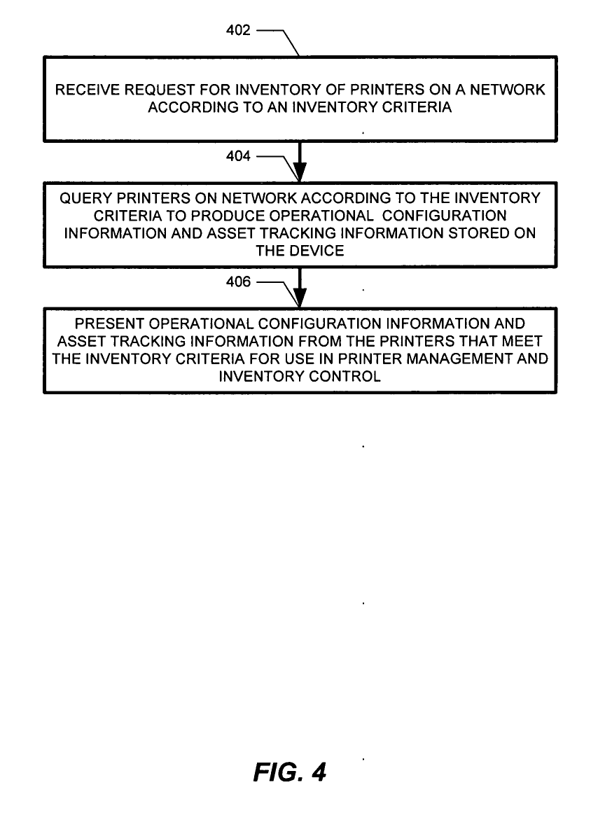

FIG. 4 is a flowchart of the operations used to locate printer and device assets in accordance with one implementation of the present invention. Implementations of the present invention initially receive requests for an inventory of printers or other devices on a network according to inventory criteria (402). The request is generally entered through a GUI such as available on the Web Jetadmin (WJA) tool developed by Hewlett-Packard Incorporated. On this and other like interfaces, an operator can specify one or more inventory criteria to search for a printer or device of interest. For example, these fields may specify asset tracking information that includes campus, building, address, floor, cost center, department, jack number, unit/room and other location details for the printer or device. It also may include other asset related information including the date installed, the person it was installed by and last updated date for record keeping purposes. The request takes one or more fields used for asset tracking and creates a search string by combining the one or more fields in a predetermined arrangement, and corresponding to the inventory criteria selected.

Next, implementations of the present invention form a query according to the inventory criteria to produce operational information and asset tracking information stored on a printer or device on the network (404). As previously described, a request is formulated into a search string by combining one or more fields in a predetermined arrangement. This query is sent as one or more messages carrying the inventory criteria over the network to the one or more printers using a network protocol. For example, this network protocol can be SNMP transmitted over TCPIP or other similar protocol. On the one or more printers on the network, aspects of the present invention then parse the messages carrying the inventory criteria into operational information and asset tracking information. Each printer compares the operational information and asset tracking information requested against one or more fields of a storage area built into a network card used by the printer.

In one implementation, the storage area built into the network card includes NVRAM and is not erased if the printer or device is recycled or powered down. Each printer may parse the messages according to a MIB object descriptor and identifier being transmitted as SNMP messages. One MIB object for holding asset tracking information has a 255 character field classified by a “sysLocation” identifier and (.1.3.6.1.2.1.1.6) descriptor.

In response, implementations of the present invention present both operational information and asset tracking information from the printers or devices that meet the inventory criteria (406). This information can be used in printer management as well as inventory control operations. For example, the inventory request for printers or other devices can be displayed on a screen displayed from the GUI of Web Jetadmin (WJA) by Hewlett-Packard. Information can also be formatted and stored in a database through a flat file or directly through an open database connectivity (ODBC) compliant interface.

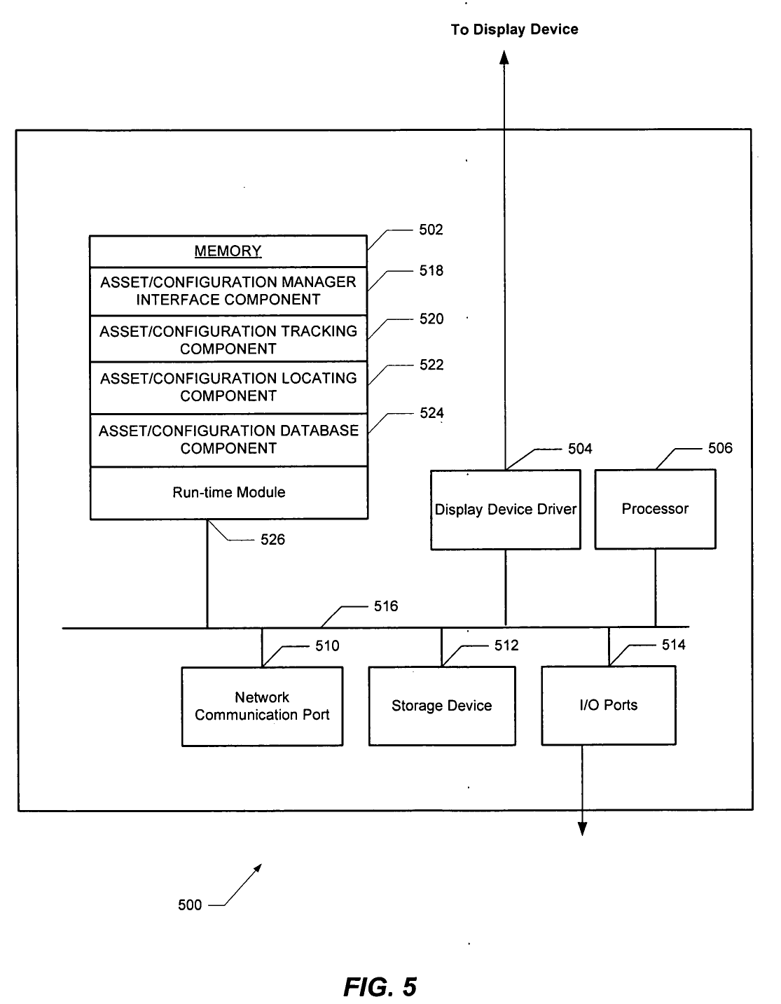

FIG. 5 is a schematic diagram of an asset management system 500 (hereinafter system 500) and logic used to track and locate printers and devices in accordance with one implementation of the present invention. System 500 includes a memory 502 to hold executing components or programs (typically random access memory (RAM) or read-only memory (ROM) such as a flash RAM), a display device driver 504, a processor 506, a network communication port 510 for data communication, a storage device 512, and input/output (I/O) ports 514 with integrated I/O controller operatively coupled together over an interconnect 516. System 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes asset/configuration manager interface component 518, asset/configuration tracking component 520, asset/configuration locating component 522, asset/configuration database component 524 and run-time module 526 that manages the resources associated with system 500. In operation, asset/configuration manager interface component 518 provides an interface to functionality provided by implementations of the present invention. For example, the Web Jetadmin GUI is one interface for accessing functionality provided by implementations of the present invention.

Asset/configuration tracking component 520 receives asset tracking information and then stores the information on one or more printers or devices over the network. Typically, asset/configuration tracking component 520 communications using an SNMP compatible protocol and stores the asset tracking information using a MIB object designated for this use. Asset/configuration database component 524 can be a MIB database containing a copy of the MIB database on a remotely located printer or device that contains this asset tracking information. Alternatively, asset/configuration database component 524 may be a local database to hold asset tracking information exported from a MIB object database stored on the remotely located printer or device. For example, exported data in asset/configuration database component 524 can be displayed in a Web Jetadmin Interface providing asset tracking information on one or more printers or devices on the network.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

Further, while specific embodiments have been described herein for purposes of illustration, various modifications may be made without departing from the spirit and scope of the invention. For example, many of the figures and descriptions pertain to printer devices however it is contemplated that aspects of the present invention can be applied to many other different types of devices and should not necessarily be limited to printer devices. For example, these devices may include scanners, copiers, telecommunication equipment and many other devices. Accordingly, the invention is not limited to the above-described implementations, but instead is defined by the appended claims in light of their full scope of equivalents.

What is claimed is:

1. A computer implemented method for tracking printer assets, comprising:
receiving operational information that enables a printer to interoperate with computers and other printers on a network;
identifying asset tracking information associated with the printer; and
storing the operational information and asset tracking information onto the printer for operation of the printer and subsequent retrieval for inventory control.

2. The method of claim 1 wherein receiving operational information further comprises:
selecting printing parameters and communication parameters for printer operation on the network.

3. The method of claim 1 wherein a Web Jet Admin (WJA) graphical user interface is used to receive operational information and identify tracking information associated with the printer.

4. The method of claim 1 wherein identifying asset tracking information further includes,
specifying a geographic location of the printer by way of an address for a building and a room in the building; and
listing one or more jacks in the room in the building that receives one or more services selected from a set of services including: power and networking.

5. The method of claim 1 wherein storing further includes,
transmitting one or more messages over the network to the printer using a network protocol;
parsing the messages into operational information and asset tracking information for the printer; and
entering the operational information and asset tracking information into one or more fields of a storage area built into a network card used by the printer.

6. The method of claim 5 wherein the network protocol is compatible with simple network management protocol (SNMP).

7. The method of claim 5 wherein the storage area is made using non-volatile random access memory (NVRAM).

8. The method of claim 5 wherein the parsing is achieved by separating the messages according to their MIB object descriptors and identifiers.

9. The method of claim 5 wherein one or more MIB entries concern asset tracking information.

10. The method of claim 1 wherein the operational information and asset tracking information are compressed before storing onto the printer.

11. The method of claim 1 wherein the compression used for storage is selected from a set of compression operation including: comma delimited and run-length encoded.

12. A computer implemented method for locating printer assets, comprising:
receiving a request for an inventory of printers on a network according to an inventory criteria;
querying one or more printers over the network according to the inventory criteria to obtain operational configuration information and asset tracking information stored on the one or more printers; and
presenting operational configuration information and asset tracking information from the printers that meet the inventory criteria for use in printer management and inventory control.

13. The method of claim 12 wherein receiving a request for an inventory further comprises:
forming the inventory criteria according to one or more fields used in asset tracking the one or more printers; and
creating a search string corresponding to the inventory criteria by combining the one or more fields in a predetermined arrangement.

14. The method of claim 12 wherein querying one or more printers further comprises:
sending one or more messages corresponding to the inventory criteria over the network to the one or more printers using a network protocol;
parsing the messages carrying the inventory criteria into operational information and asset tracking information for the one or more printers; and
comparing the operational information and asset tracking information against one or more fields of a storage area built into a network card used by each of the one or more printers.

15. The method of claim 12 wherein a Web Jet Admin (WJA) graphical user interface is used to receive the request for the inventory of printers.

16. The method of claim 12 wherein querying one or more printers over the network is accomplished using a network protocol compatible with simple network management protocol (SNMP).

17. The method of claim 12 wherein presenting the operational configuration information and asset tracking information occurs in a display area of a web browser running on a computer.

18. The method of claim 12 wherein presenting the operational configuration information and asset tracking information occurs by entering the information into a database.

19. A computer program product, tangibly stored on a computer-readable medium, for tracking printer assets, comprising instructions operable to cause a programmable processor to:
receive operational information that enables a printer to interoperate with computers and other printers on a network;
identify asset tracking information associated with the printer; and
store the operational information and asset tracking information onto the printer for operation of the printer and subsequent retrieval for inventory control.

20. The computer program product of claim 19 further comprising instructions that:
specify a geographic location of the printer by way of an address for a building and a room in the building; and
list one or more jacks in the room in the building that receives one or more services selected from a set of services including: power and networking.

21. The computer program product of claim 19 wherein the instructions that store further include instructions that,
transmit one or more messages over the network to the printer using a network protocol;
parse the messages into operational information and asset tracking information for the printer; and
enter the operational information and asset tracking information into one or more fields of a storage area built into a network card used by the printer.

22. The computer program product of claim 19 wherein the network protocol is compatible with simple network management protocol (SNMP).

23. The computer program product of claim 21 wherein the storage area is made using non-volatile random access memory (NVRAM).

24. The computer program product of claim 21 wherein the parsing is achieved by separating the messages according to their MIB object descriptors and identifiers.

25. A computer program product, tangibly stored on a computer-readable medium, for locating printer assets, comprising instructions operable to cause a programmable processor to:
receive a request for an inventory of printers on a network according to an inventory criteria;
query one or more printers over the network according to the inventory criteria to obtain operational configuration information and asset tracking information stored on the one or more printers; and
present operational configuration information and asset tracking information from the printers that meet the inventory criteria for use in printer management and inventory control.

26. The computer program product of claim 25 wherein the instructions that query one or more printers further comprises instructions that:
send one or more messages corresponding to the inventory criteria over the network to the one or more printers using a network protocol;
parse the messages carrying the inventory criteria into operational information and asset tracking information for the one or more printers; and
compare the operational information and asset tracking information against one or more fields of a storage area built into a network card used by each of the one or more printers.

27. The computer program product of claim 25 wherein the instructions used to receive the request for the inventory of printers further generate a Web Jet Admin (WJA) graphical user interface.

28. The computer program product of claim 25 wherein the instructions that query one or more printers over the network further include instructions that use a network protocol compatible with simple network management protocol (SNMP).

29. An apparatus for tracking printer assets, comprising:
means for receiving operational information that enables a printer to interoperate with computers and other printers on a network;
means for identifying asset tracking information associated with the printer; and
means for storing the operational information and asset tracking information onto the printer for operation of the printer and subsequent retrieval for inventory control.

30. An apparatus for locating printer assets, comprising:
means for receiving a request for an inventory of printers on a network according to an inventory criteria;
means for querying one or more printers over the network according to the inventory criteria to obtain operational configuration information and asset tracking information stored on the one or more printers; and
means for presenting operational configuration information and asset tracking information from the printers that meet the inventory criteria for use in printer management and inventory control.
